(19) United States
(12) Patent Application Publication
(10) Pub. No.: US 2023/0080028 A1
(43) Pub. Date: Mar. 16, 2023

(54) SUPERVISED GRAPH LEARNING

(71) Applicant: Mission Solutions Group, Inc., North Charleston, SC (US)

(72) Inventor: Noah B. Jacobsen, North Charleston, SC (US)

(21) Appl. No.: 17/718,787

(22) Filed: Apr. 12, 2022

Related U.S. Application Data
(60) Provisional application No. 63/244,781, filed on Sep. 16, 2021.

(51) Int. Cl. G06N 3/08; G06N 3/04

(52) U.S. Cl. CPC G06N 3/08; G06N 3/0472

(57) ABSTRACT

The present disclosure relates to supervised graph learning. In aspects, a system includes one or more processors and at least one memory storing instructions. The instructions, when executed by the processor(s), cause the system to access training data relating to variables, determine a factor graph model based on the training data where the factor graph model includes component factors, estimate probability density functions for the component factors based on Monte Carlo integration in the frequency domain, and apply the factor graph model with the estimated probability density functions for the component factors to new observed data to make a prediction.

### CROSS-REFERENCE TO RELATED APPLICATIONS

The present application claims the benefit of and priority to U.S. Provisional Application No. 63/244,781, filed Sep. 16, 2021, which is hereby incorporated by reference herein in its entirety.

### TECHNICAL FIELD

The present disclosure relates to machine learning and, more particularly, to supervised graph learning that creates a probabilistic graph, without any predetermined graph structure, using training data.

### BACKGROUND

A graph is a data structure that includes nodes and edges. There are many different types of graphs, such as undirected graphs, directed graphs, hypergraphs, graphs with self-edges, graphs without self-edges, and/or bipartite graphs, among others. Graphs are applicable to widespread numbers and types of applications, including classification tasks, for example.

### SUMMARY

The present disclosure relates to supervised graph learning that creates a probabilistic graph, without any predetermined graph structure, using training data. The present disclosure provides an improvement to technology in the machine learning field and creates graph models that have no predetermined structure prior to the training. The graph models created by the disclosed technology can be applied to new observed data to make predictions/inferences. Unless indicated otherwise by context, the terms “inference” and “prediction” may be used interchangeably herein.

In accordance with aspects of the present disclosure, a system includes one or more processors and at least one memory storing instructions. The instructions, when executed by the one or more processors, cause the system to access training data relating to a plurality of variables, determine a factor graph model based on the training data where the factor graph model includes component factors, estimate probability density functions for the component factors based on Monte Carlo integration in frequency domain, and provide the factor graph model with the estimated probability density functions for the component factors.

In various embodiments of the system, in determining the factor graph model, the instructions, when executed by the one or more processors, cause the system to determine low-order moments based on the training data.

In various embodiments of the system, in determining the factor graph model, the instructions, when executed by the one or more processors, cause the system to identify subsets of dependent variables based on the low-order moments.

In various embodiments of the system, in identifying the subsets of dependent variables, the instructions, when executed by the one or more processors, cause the system to compare whether joint variable moments deviate from products of individual variable moments.

In various embodiments of the system, in determining the factor graph model, the instructions, when executed by the one or more processors, cause the system to create factor nodes corresponding to the subsets of dependent variables and adding edges from the factor nodes to corresponding variable nodes.

In various embodiments of the system, in estimating probability density functions for the component factors, the instructions, when executed by the one or more processors, cause the system to estimate functional forms of the probability density functions for the component factors using Fourier domain synthesis.

In various embodiments of the system, in estimating probability density functions for the component factors, the instructions, when executed by the one or more processors, cause the system to estimate the probability density functions for the component factors using the functional forms, joint variable moments, and direct Monte Carlo integration in the frequency domain.

In various embodiments of the system, the instructions, when executed by the one or more processors, further cause the system to apply the factor graph model with the estimated probability density functions for the component factors to observed variables to make an inference.

In accordance with aspects of the present disclosure, a method includes accessing training data relating to a plurality of variables, determining a factor graph model based on the training data where the factor graph model includes component factors, estimating probability density functions for the component factors based on Monte Carlo integration in frequency domain, and providing the factor graph model with the estimated probability density functions for the component factors.

In various embodiments of the method, determining the factor graph model includes determining low-order moments based on the training data.

In various embodiments of the method, determining the factor graph model includes identifying subsets of dependent variables based on the low-order moments.

In various embodiments of the method, identifying the subsets of dependent variables includes comparing whether joint variable moments deviate from products of individual variable moments.

In various embodiments of the method, determining the factor graph model includes creating factor nodes corresponding to the subsets of dependent variables and adding edges from the factor nodes to corresponding variable nodes.

In various embodiments of the method, estimating the probability density functions for the component factors includes estimating functional forms of the probability density functions for the component factors using Fourier domain synthesis.

In various embodiments of the method, estimating the probability density functions for the component factors includes estimating the probability density functions for the component factors using the functional forms, joint variable moments, and direct Monte Carlo integration in the frequency domain.

In various embodiments of the method, the method includes applying the factor graph model with the estimated probability density functions for the component factors to observed variables to make an inference.

In accordance with aspects of the present disclosure, a non-transitory computer-readable medium stores instructions which, when executed by a computer, causes the computer to perform a method that includes accessing training data relating to a plurality of variables, determining a factor graph model based on the training data where the factor graph model includes component factors, estimating probability density functions for the component factors based on Monte Carlo integration in the frequency domain, and providing the factor graph model with the estimated probability density functions for the component factors.

In accordance with aspects of the present disclosure, a method includes: accessing training data relating to a plurality of variables; determining a probabilistic graph model based on the training data, where the probabilistic graph model includes nodes and edges deduced from the training data and where the probabilistic graph model has no predetermined structure prior to the nodes and edges being deduced; estimating probabilistic parameters of the probabilistic graph model using the training data; and applying the probabilistic graph model with the estimated probabilistic parameters to new observed data to make a prediction.

In various embodiments of the method, the probabilistic graph model is a factor graph model.

Further details and aspects of exemplary embodiments of the present disclosure are described in more detail below.

### BRIEF DESCRIPTION OF THE DRAWINGS

FIG. 1 is a flow diagram of an exemplary operation, in accordance with aspects of the present disclosure;

FIG. 2 is a diagram of an exemplary factor graph corresponding to an error correction system, in accordance with aspects of the present disclosure;

FIG. 3 is a diagram of exemplary matrices relating to the error correction system, in accordance with aspects of the present disclosure;

FIG. 4 is a diagram of exemplary computations relating to sum-product algorithm, in accordance with aspects of the present disclosure;

FIG. 5 is a diagram of further exemplary computations relating to sum-product algorithm, in accordance with aspects of the present disclosure;

FIG. 6 is a diagram of exemplary bit error rate curves, in accordance with aspects of the present disclosure;

FIG. 7 is a diagram of exemplary parameters relating to neural network implementations, in accordance with aspects of the present disclosure; and

FIG. 8 is a block diagram of exemplary components of a computing system, in accordance with aspects of the present disclosure.

### DETAILED DESCRIPTION

The present disclosure relates to supervised graph learning that creates a probabilistic graph, without any predetermined graph structure, using training data. The present disclosure provides an improvement to technology in the machine learning field and creates graph models that have no predetermined structure prior to the training. The graph models created by the disclosed technology can be applied to new observed data to make predictions/inferences.

A system may be characterized by variables. For example, a system for predicting temperature may have variables such as location (e.g., longitude and latitude), time of year (e.g., number of days since start of the year), time of day, weather conditions (e.g., sunny, rainy, etc.), and traffic congestion level, among other variables. Systems for other applications have other variables. In various embodiments, a system variable may be a variable that is observable (e.g., measured by a sensor) or a variable that is not observable but may be computed, e.g., a variable whose value is to be predicted.

As mentioned above, a graph is a data structure that includes nodes and edges. As used herein, a “probabilistic graph” is a graph that models statistical relationships within a system of variables, such as statistical relationships between system inputs and system outputs or statistical relationships between variables or subgroups of variables of the system.

One example of a probabilistic graph is a factor graph. A factor graph is a bipartite graph, in which (a) there are two-types of nodes: variable nodes and factor nodes, and (b) edges of the graph connect only to nodes of different type (i.e., edges connect only variable nodes to factor nodes). The variable nodes represent the variables of the system, and the factor nodes represent the component factors (local statistical dependence) of the global system. Edges of the factor graph connect factor nodes to variable nodes if and only if the corresponding factor is a function of the corresponding variable.

The disclosed technology is generally applicable to probabilistic graphs. Factor graphs are used as the primary example, but it is intended that any disclosure herein relating to factor graphs may be applied to probabilistic graphs.

The present disclosure improves the technology of the information theory, artificial intelligence, and machine learning disciplines. In accordance with aspects of the present disclosure, the disclosed technology realizes a generalized graph-based framework for automated learning in intelligent systems. Aspects of the present disclosure provide automatic graph learning framework employs factor graphs to represent any stochastic system of variables and factorized realizations of their joint probability density function. Algorithms are disclosed that are capable of learning statistical relationships between system variables, which, in various embodiments, involves constructing an appropriate factor graph representation and generating estimates of its component probability density functions, from training data.

As used herein, the terms “automatic graph learning” and “supervised graph learning” may be used interchangeably to refer to machine learning that uses training data to create a probabilistic graph that represents a stochastic system of variables, including factor graphs which represent factorized realizations of joint probability density functions of system variables. Unlike machine learning using neural networks (NN), which trains a predetermined network having a predetermined structure, the automatic graph learning of the present disclosure does not start with any predetermined graph structure. Although graphical structure is a basic characteristic of neural networks, there is a disconnect between the NN model and probability law governing its variables or features. Specific instances of neural networks such as convolutional neural networks and recurrent neural networks have demonstrated a high degree of success in several areas including object recognition and natural language processing. However, there is no generalized NN or NN-based framework that could be applied to any learning system. Unlike neural networks, and as described in more detail below, the probabilistic graphs created by the automatic graph learning disclosed herein can result in any structure deduced from the training data.

Aspects of the disclosed technology use probability and information theory for modeling stochastic systems and implementing probabilistic inference algorithms and use supervised learning, i.e., training-based learning from principles of probability theory. As described above, a graph model for the system in question is a priori unknown, and training data is used to deduce an appropriate probabilistic graph model and, in the case of factor graphs, functional approximation of its component factors. The developed methodology is general in the sense that it can be applied to any data system, wherein a suitable probabilistic graph model is automatically learned from training data and inference computations are performed on the learned graph. In the case of factor graph system models, and given a characterization of is component factors, an instance of the sum-product algorithm can be used to compute marginal densities, such as the a posteriori probabilities, on non-observed system variables.

In accordance with aspects of the present disclosure, the disclosed technology provides a generalized learning framework that captures statistical structure between a system of variables. Using factor graphs as an example, the disclosed automatic graph learning/supervised graph learning uses empirical estimates of low-order statistical moments to (i) select dependent subsets of variables to construct a system factor graph model and (ii) generate estimates of the functional form of the resulting factors via Fourier domain synthesis. Given the factor graph model and functional characterization of its component factors, the sum-product algorithm is then used to implement probabilistic inference computations.

In contrast to techniques which select the best model from a predefined set of candidate models, the present disclosure builds a unified framework in which an appropriate probabilistic graph model for representing and processing inference for a system of data is automatically learned from training data. As explained in more detail later herein, the disclosed technology imposes no constraint on the family of densities used to model the posterior density, factor densities, or other densities that arise in belief propagation. Furthermore, as explained later herein, instead of truncating the Fourier series of factor density functions, the disclosed technology uses the relationship of Fourier coefficients to statistical moments to form estimates of the component factors based on truncated orders of moments. As persons skilled in the art will understand, statistical moments are a set of parameters that measure a probability distribution, such as the first four moments: mean, variance, skew and kurtosis. Higher order moments, as well as joint moments involving multiple random variables, are utilized in this disclosure for completely characterizing the joint probability distribution function of subsystems of random variables.

The disclosed technology further leverages direct Monte Carlo integration of the joint density function in the Fourier domain. The disclosed technology also uses training data to estimate statistical moments via Monte Carlo integration, and the methods are more general because they do not assume that the output is in the form of statistical expectation. Rather, the disclosed technology estimates the density functions directly in the Fourier domain and uses the relationship of the Fourier coefficients to statistical moments. Accordingly, the present disclosure applies a statistical moments-based approach for constructing probabilistic graphical models.

In accordance with aspects of the present disclosure, the disclosed technology enables learning a factor graph model representative of statistical relationships between a system of variables. In various embodiments, a factor graph model can be learned by using estimates (from training data) of low-order statistical moments. For example, subsets of variables of a system may be tested for dependence, based on the estimated moments from training data, by checking whether their joint moments deviate from the product of their individual moments. Dependent subsets can be selected to construct a factor graph for the system of variables. Graphically, this amounts to creating factor nodes corresponding to the selected subsets of variables and adding edges from the factor nodes to their corresponding variable nodes, to thereby create a factor graph.

In accordance with aspects of the present disclosure, after a factor graph model is learned, the disclosed technology may determine probability density functions of the component factors. In various embodiments, estimates of component factor probability density functions may be generated using Fourier domain representations and Monte Carlo integration. Fourier coefficients have a relationship to statistical moments. Because component factors were determined using low-order statistical moments, and statistical moments have a relationship with Fourier coefficients, Fourier domain synthesis may be used to estimate the functional form of the component factor probability density functions. Using the Fourier transform synthesis equation, estimates of the component factor probability density functions can be determined using estimates of the joint statistical moments between the system variables or by leveraging direct Monte Carlo integration of the joint density function in the Fourier domain, as described in subsequent sections.

The result of such operations are a learned factor graph model with estimated probability density functions for the component factors. Because the factor graph model is learned from training data, the operations of the present disclosure are referred to herein as “supervised graph learning.”

Accordingly, supervised graph learning provides a factor graph model with estimated probability density functions for the component factors. To apply the learned factor graph model to observed variables to make an inference, an instance of the sum-product algorithm can be implemented to process the observed variables and make an inference.

Accordingly, supervised graph learning and using the sum-product algorithm to apply a learned factor graph to observed variables are disclosed herein.

The disclosed technology uses training data to learn a factor graph model of the data system and develops estimates of the factor probability density functions (PDFs). A “probability density function” is a term of art. As persons skilled in the art will understand, a probability density function is non-negative everywhere, and its integral over the entire space is equal to one. A PDF can be used to specify the probability of the random variable falling within a particular range of values. As explained below, the estimates of the factor density functions are built using estimates of the joint statistical moments between the system variables and Monte Carlo integration. The disclosed techniques leverage the theorem below, which is described using continuous-time Fourier transforms. Persons skilled in the art will understand how to apply the disclosed techniques using discrete-time Fourier transforms and Fast Fourier Transforms, among other Fourier transform implementations.

Theorem 1

The joint PDF of X and Y, denoted f_{XY}(x, y), is uniquely determined by its joint statistical moments, E[X^{m}Yⁿ], for all m=1,2,3 . . . and n=1,2,3, . . .

Proof

The theorem follows from substituting the Taylor expansion of the complex exponential in the multivariate Fourier transform of the joint PDF f_{XY}(x, y).

The PDF of X and Y can be expressed as:

f_{XY}(x,y)=∫_{-∞}^{∞}∫_{-∞}^{∞}F_{XY}(ω₁,ω₂)e^{i2π(ω}^{₁}^{x+ω}^{₂}^{y)}dω₁dω₂, EQUATION 1

where F_{XY}(ω₁, ω₂) denotes the two-dimensional Fourier transform of f_{XY}(x, y):

$${F}_{X Y} ( {ω}_{1} , {ω}_{2} ) = \frac{1}{{( 2 π )}^{2}} {\int }_{- ∞}^{∞} {\int }_{- ∞}^{∞} f ( x , y ) {e}^{- i 2 π ( {ω}_{1} x + {ω}_{2} y )} d xdy = \frac{1}{{( 2 π )}^{2}} E [ {e}^{- i 2 π ( {ω}_{1} X + {ω}_{2} Y )} ] = \frac{1}{{( 2 π )}^{2}} {\sum }_{m = 0}^{∞} {\sum }_{n = 0}^{∞} {( - i2 π )}^{m + n} \frac{{ω}_{1}^{m}}{m !} \frac{{ω}_{2}^{n}}{n !} E [ {X}^{m} {Y}^{n} ] . \qquad EQUATION 2$$

Hence, assuming convergence of the integrals in Equation 1 and Equation 2, the PDF f_{XY}(x, y) is expressed in terms of its joint moments E[X^{m}Yⁿ] for all m>0 and n>0.

Corollary 1

The random variables X and Y are independent if and only if the following equation holds for all values of m>0 and n>0:

E[X^{m}Yⁿ]=E[X^{m}]E[Yⁿ]. EQUATION 3

Proof

For X and Y independent, we have f_{XY}(x, y)=f_{X}(x)f_{Y}(y), which implies that F_{XY}(ω₁, ω₂)=F_{X}(ω₁)F_{Y}(ω₂) and thus we can write the following:

$${{{E [ {X}^{m} {Y}^{n} ] = \frac{{( 2 π )}^{2}}{{( - i 2 π )}^{m + n}} \frac{{\partial }^{m + n} {F}_{X Y} ( {ω}_{1} , {ω}_{2} )}{{\partial }^{m} {ω}_{1} {\partial }^{n} {ω}_{2}} \vert}_{{ω}_{1} = 0 , {ω}_{2} = 0} = \frac{{( 2 π )}^{2}}{{( - i 2 π )}^{m + n}} \frac{{d}^{m} {F}_{X} ( {ω}_{1} )}{{d}^{m} {ω}_{1}} \vert}_{{ω}_{1} = 0} \frac{{d}^{n} {F}_{Y} ( {ω}_{2} )}{{d}^{n} {ω}_{2}} \vert}_{{ω}_{2} = 0} = E [ {X}^{m} ] E [ {Y}^{n} ] ,$$

where we have assumed that the appropriate conditions for interchanging the order of differentiation and expectation hold true.

Conversely, substituting E[X^{m}Yⁿ]=E[X^{m}]E[Yⁿ] in Equation 2 yields F_{XY}(ω₁, ω₂)=F_{X}(ω₁)F_{Y}(ω₂) and thus f_{XY}(x,y)=f_{X}(x)f_{Y}(y).

The above results extend to larger multivariate PDFs, wherein the joint statistical moments must be taken between all combinations of exponents and variables. A result of Corollary 1 is that if Equation 3 does not hold true for any m and n, then X and Y must be dependent random variables—a property that may be used to check for dependence among subsets of system variables.

In accordance with aspects of the present disclosure, statistical moments estimated from training data are used to select dependent subsets of system variables and, thus, a factorization of the system PDF, as in Equation 4 below. Equation 2 can then be used to estimate the functional form of the component factors. Assuming a stationary system (joint statistics are time-invariant), and independent identically distributed (IID) training data (xᵢ, yᵢ), i=1, . . . , T, we have the following empirical estimates for the joint moments of X and Y:

$$E [ {X}^{m} {Y}^{n} ] = {lim}_{T \to ∞} \frac{1}{T} {\sum }_{i = 1}^{T} {x}_{i}^{m} {y}_{i}^{n} , 0 < m , n < ∞ ,$$

which follows from the law of large numbers. In various embodiments, reduced complexity estimates can be obtained by using only low order, low degree moments to select factors and to estimate Equation 2.

Since the component factors of the system posterior density depend only on subsets of system variables, the complexity of joint PDF estimation is reduced. Moreover, inference processing using the sum-product algorithm benefits from small factor size in terms of complexity and performance.

The disclosed technology, with respect to factor graphs, can be viewed as having three phases: 1. factor selection, 2. factor density estimation, and 3. execution of the sum-product algorithm with the learned model to make inferences based on new data. These phases are described in detail below.

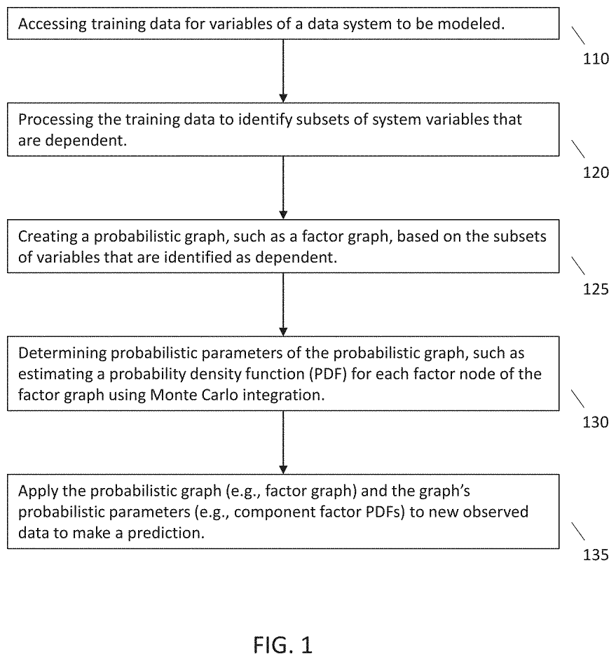

Referring FIG. 1, there is shown a flow diagram of an operation for using supervised learning to create a factor graph without any predetermined graph structure and for applying the factor graph to new data to make inferences. Factor graphs are used as an example, and it will be understood that aspects of the present disclosure are applicable to probabilistic graphs in general.

At block 110, the operation involves accessing training data for variables of a data system to be modeled. The training data includes data for observable system variables. In various embodiments, the training data includes data for non-observable system variables.

At block 120, the operation involves processing the training data to identify subsets of system variables that are dependent. The operations of block 120 encompass the factor selection phase mentioned above. In this phase, subsets of variables can be tested for dependence by determining empirical moments from training data and dependent subsets are selected to construct a factor graph for the system of variables. Graphically, this amounts to creating a set of factor nodes corresponding to the selected subsets of variables and adding edges from the factors to their corresponding variable nodes.

In accordance with aspects of the present disclosure, a technique to select factors follows from Corollary 1. In particular, the operation identifies dependent subsets of variables by checking how much their joint moments, measured from training data, deviate from the product of their individual moments. For example, if V₁ and V₂ represent dependent system variables, then there exists a pair of exponents (m, n) such that 0<Δₘₙ [symbol] |E[V₁^{m}V₂ⁿ]−E[V₁^{m}]E[V₂ⁿ]|. A larger deviation Δₘₙ from zero indicates a greater degree of confidence that the variables exhibit dependence. Thus the Δₘₙ serve as a metric for ranking dependent subsets. In the case of binary data, E[V₁^{m}V₂ⁿ]=E[V₁V₂] for all m and n greater than zero. Hence, for binary data, it suffices to measure only the first order moments. In general, all orders of joint moments must be determined to fully characterize the joint probability density function of the subsystem of random variables, but there are exceptions, such as the binary case noted above and the Gaussian case which is fully characterized by its first and second order moments. However, heuristic criteria can be used to limit the search space, as described below.

In various embodiments, the training data may be normalized to have zero mean and unit variance. Letting vᵢ [1], . . . , vᵢ[T] denote T realizations of the random variable Vᵢ, the operation can set: v̅ᵢ[t]=σᵢ⁻¹(vᵢ[t]−μᵢ), where μᵢ=T⁻¹ Σvᵢ[t] and σᵢ²=T⁻¹Σ(vᵢ[t]−μᵢ)². The operation then constructs the metrics Δᵢⱼ=|T⁻¹Σv̅ᵢ [t]v̅ⱼ[t]| and identifies those that exceed a predetermined threshold value. In various embodiments, the operation can add degree-three factors whose joint empirical moments exceed another predetermined threshold value. Hence, the operation can identify deviations of the joint moments from the product of their individual moments over the ensemble and determine thresholds {τ_{d}} for detecting variable dependence per degree of subset d.

In various embodiments, due to the combinatorial complexity of factor detection for massive systems, heuristic criteria can be used to limit the search space for candidate variable subsets, such as those described above. In various embodiments, low-order/low-degree statistical moments (e.g., m, n<5 or m, n<10, etc.) can be used as the primary basis for selecting dependent subsets of variables. In various embodiments, approaches for reducing complexity include sparse graphs, clustering methods, random sampling, and physical models, among others.

At block 125, the operation involves creating a probabilistic graph, such as a factor graph, based on the subsets of variables that are identified as dependent. As mentioned above, the probabilistic graph that is created does not have any predetermined structure. Rather, in the case of factor graphs, the factor graph is created by creating a set of factor nodes corresponding to the dependent subsets of variables and by adding edges from the factors to their corresponding variable nodes.

Use of statistical moments to determine dependence and to create nodes and edges is merely an example, and heuristics or metrics other than statistical moments may be used. Such other heuristics or metrics may be used to create probabilistic graphs other than factor graphs. Such other heuristics and metrics and probabilistic graphs are contemplated to be within the scope of the present disclosure.

At block 130, the operation involves determining probabilistic parameters of the probabilistic graph created in block 125. More specifically, for a factor graph, the operation involves estimating a probability density function for each factor node of the factor graph using Monte Carlo integration. As persons skilled in the art will understand, Monte Carlo integration as used herein refers to an empirical technique for determining the expected value of a statistical quantity which may be written as an integral of the quantity against its probability density function. The operations of block 130 encompass the factory density estimation phase mentioned above.

The operations of block 130 can characterize the functional form of the component factors of a global system PDF. The operation assumes that each component factor represents the joint PDF of its connected variables, i.e. posterior densities over the variables. For example, if {V₁, V₂} and {V₂, V₃, V₄} were identified as the dependent subsets of variables of a four variable system, then the global PDF can be expressed by f(V₁, V₂, V₃, V₄)∝f₁(V₁, V₂)f₂ (V₂, V₃, V₄). To solve for the functional form of the factor PDF, f₁ and f₂, Theorem 1 can be used to construct estimates of the densities using empirical measurements of the joint statistical moments taken from training data via Monte Carlo integration as in Equation 2, or similarly, by directly computing the expected value of the complex exponential in Equation 2 via Monte Carlo integration. In various embodiments, the complexity of this phase may be mitigated by restricting attention to low-order moments or truncating the summations when building estimates of the component factors.

Monte Carlo integration is provided as an example for characterizing the functional form of factors and estimating probability density function from training data. Other embodiments are contemplated for characterizing the functional form of factors and estimating probability density function from training data. Such other embodiments are contemplated to be within the scope of the present disclosure.

At block 135, the operation applies the probabilistic graph (e.g., factor graph) created at block 125 and the probabilistic graph's probabilistic parameters (e.g., component factor PDFs) determined at block 130 to new observed data to make a prediction.

Once the factor graph and its component densities are determined, the operation of block 135 implements an algorithm that applies the component densities to compute inferences based on new data. As an example, the algorithm may use an instance of the sum-product algorithm for computing inferences on certain system variables based on observed system variables, or using various message passing techniques. Aspects of implementing the sum-product algorithm are described in F. R. Kschischang, B. J. Frey and H. A. Loeliger, “Factor graphs and the sum-product algorithm,” IEEE Transactions on Information Theory, vol. 47, no. 2, pp. 498-519, February 2001, which is hereby incorporated by reference herein in its entirety. Persons skilled in the art will understand how to implement the sum-product algorithm to compute inferences using component densities. Since multiple factor graphs can be used to model the same data system, it is advantageous to choose graphs with desirable properties for the inference algorithm. Sparse graphs with large girth may yield better performance. In various embodiments, low-degree factors may be selected before considering high-degree factors when constructing the factor graph model.

The descriptions provided in connection with FIG. 1 are examples. Variations are contemplated to be within the scope of the present disclosure.

Accordingly, aspects of the modeling and inference framework described above may be based on factor graphs and application of the sum-product algorithm for estimating the state of system variables to be predicted, given the state of observed system variables. Factor graphs provide a basic framework for representing any data system as the product of several lower-complexity component densities. Given a specification of the component factors, the sum-product algorithm can be implemented directly from the graph representation to compute marginal densities on system variables to be predicted.

As an example of the operations of FIG. 1, the following will describe using automatic graph learning to reverse engineer the Hamming code, based on training data comprised of input-output codeword pairs. As shown below, automatic graph learning is capable of replicating known decoder performance with an order of magnitude less training data than a multi-layer dense neural network.

The following describes the factor graph representation of the (6,3) Hamming code, which is a binary linear code with maximal codeword distance for its code rate. The notation (6,3) refers to the codeword length (6-bits) and number of input bits (3-bits), which results in a code rate of 1/2 (ratio of input bits to code bits). A systematic binary linear code includes the input bits as part of the output codeword.

The following also illustrates the application of factor graphs and the sum-product algorithm using a binary linear code, specifically the (6,3) Hamming code, and describes applying the AGL framework to reverse engineer a decoder for the (6,3) Hamming code based on training data of input-output codeword pairs. In the following, an abbreviated notation for the joint PDF may be used for compactness, where f_{xy}(x, y) is written as f Y).

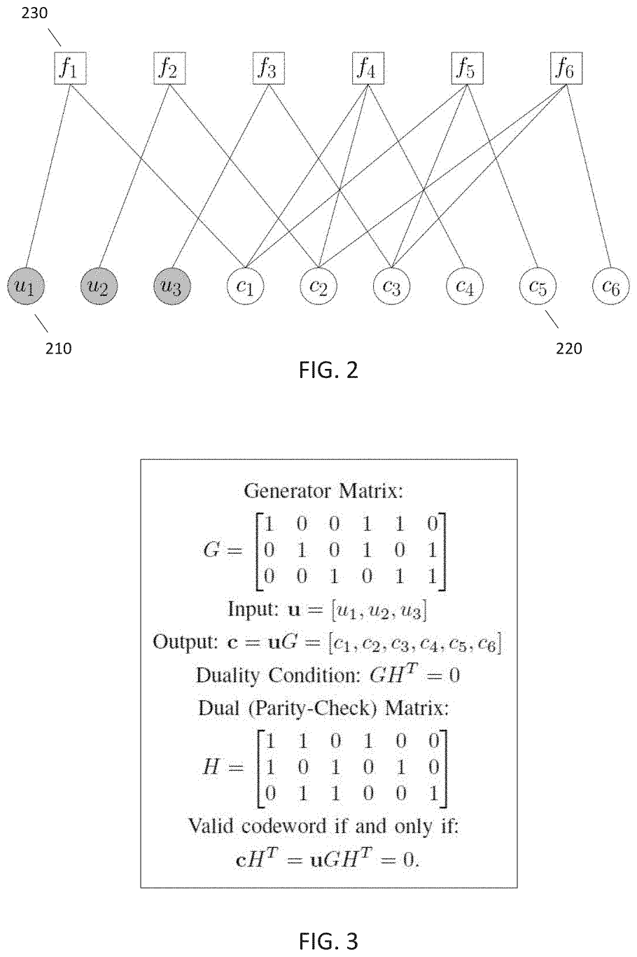

FIG. 2 depicts a factor graph relating the input and output bits of a (6,3) Hamming code. The input bits uᵢ, i=1,2,3 are collectively designated as 210 and the output bits cᵢ, i=1,2, . . . ,6 are collective designated as 220. Factors f₁, f₂, and f₃ represent equality constraints on the systematic code bits and factors f₄, f₅, and f₆ correspond to the parity check equations. The factors are collectively designated as 230.

Let U=(U₁, . . . ,Uₖ) represent uncoded information bits 210 and C=(C₁, . . . , Cₙ) represent codewords 220 of the (n=6, k=3) Hamming code, where C₁=U₁, C₂=U₂ and, C₃=U₃ are the systematic code bits and C₄=C₁+C₂, C₅=C₁+C₃, and C₆=C₂+C₃ are the parity bits (modulo-two arithmetic). The codewords of a binary linear code are given by matrix multiplication with the generator matrix, G, and are orthogonal to the parity check matrix, H, as defined in FIG. 3 for the (6,3) Hamming code. The rows of H span the null space of G and correspond to factor nodes 230 of the factor graph representation of the code, as shown in FIG. 2. Any valid codeword must satisfy the parity check equations defined by the dual matrix.

Let V=(U, C) denote the system variables. For the (6,3) Hamming code, we can write a joint PDF for the system of variables as:

f(V)=f₁(U₁,C₁)f₂(U₂,C₂)f₃(U₃,C₃)f₄(C₁,C₂,C₄)f₅(C₁,C₃,C₅)f₆(C₂,C₃,C₆), EQUATION 4

where fᵢ, i=1,2,3, represents the equality constraint on the systematic bits and the remaining factors correspond to parity check constraints. Equation 4 is expressed as a factor graph in FIG. 2. Whereas the information bits are usually omitted from the code's factor graph, these variable nodes are included to learn a model that is able to compute inferences on the variables to be predicted in a general system.

For numerical evaluations, we use Binary Phase Shift Keying (BPSK) modulation with real Additive White Gaussian Noise (AWGN) channel with for the received signal model:

Yᵢ=(−1)^{C}^{ᵢ}+Wᵢ,

where E[Wᵢ²]=N₀ and the signal-to-noise ratio is SNR=N₀⁻¹. The a posteriori probability of the transmitted bits is given by:

f(V|Y)∝f(V)Πf(Yᵢ|Cᵢ),

where Y=(Y₁, . . . , Y₆). The channel output likelihoods {f(Yᵢ|Cᵢ)} are often depicted as dongles hanging from the code bit variable nodes 220 in FIG. 2, reflecting that they are a function only of the {Cᵢ} given the channel output {Yᵢ}.

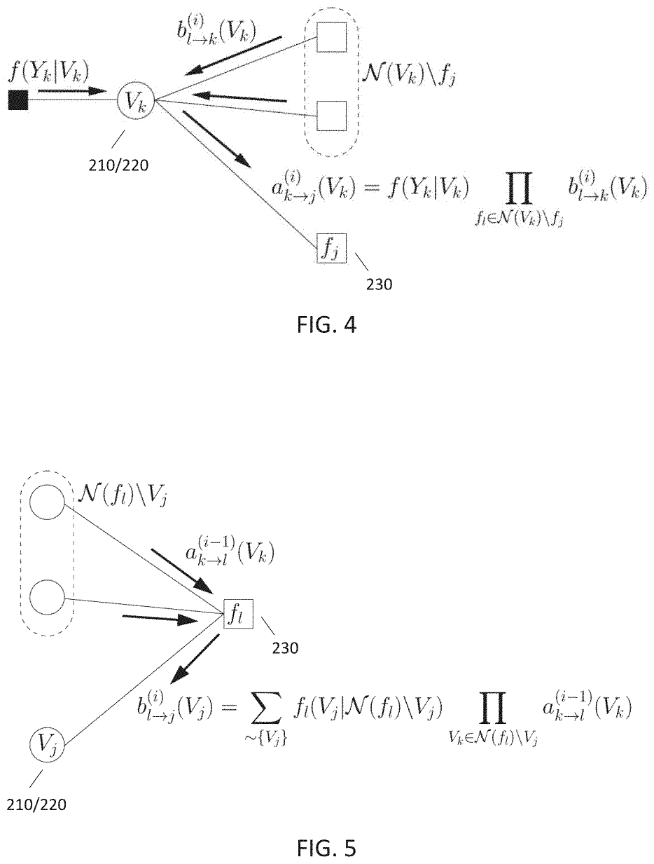

There is a one-to-one correspondence between the edges of the factor graph in FIG. 2 and the nonzero elements of the parity check matrix defined in FIG. 3. Hence the binary linear code can be constructed as a factor graph (in the dual domain), chosen for its desirable characteristics for the decoder algorithm, such as density propagation and maximum size of the minimum loop (i.e., maximum girth). The belief propagation decoder is an instance of the sum-product algorithm. Belief propagation comprises iterative message massing between nodes of the graph, as illustrated in FIG. 4 (variable node 210/220 update of belief propagation) and FIG. 5 (factor node 230 update of belief propagation). The algorithm assumes that an outgoing message on a graph edge is independent from the incoming message on the same edge. This assumption is violated after sufficiently many iterations for messages to traverse the length of the minimum loop. Nonetheless belief propagation is an appropriate algorithm for inference processing on graphs and the result of so-called loopy belief propagation is approximate after the number of iterations exceeds one-half of the girth of the graph.

Given a factor graph model, its component PDF's can be estimated using empirical measurements of relevant system moments derived from training data. In various embodiments, low-order, low-degree moments may be used to generate approximate estimates of factors of the system PDF. Given the graph model and estimates of its corresponding factors, the sum product algorithm can be directly applied to compute the conditional PDF's of system variables of the graph to be predicted, given the status of observed system variables. Variable node processing and factor node processing steps of the sum-product algorithm are illustrated in FIG. 4 and FIG. 5, for the case of binary parity check data.

The following describes using the proposed AGL framework to reverse engineer the (6,3) Hamming code based on training data of T input-output codeword pairs.

Phase I: Factor Selection

For the reverse engineering example, the thresholds are chosen to yield full rank parity check matrices with high reliability over randomly selected training data and used only degree-2 and degree-3 factors. In various embodiments, factor degrees can be selected according to a prescribed degree distribution derived from mutual information transfer analysis of the training data.

In various embodiments, other constraints can be imposed on the factor selection candidate set. For example, a linear independence condition can be enforced such that a new factor will be added to the graph only if it is linearly independent from the set of existing factors. This condition prohibits over-determining the system factors arising from multiple ways of factoring coupled sets of dependent variables. Similarly, limiting the rank of the graph to the dimension of the observed variables prevents over-determining the factors of the system. Additionally, any new factor that overlaps with an existing factor by two or more variables can be discarded. This condition avoids the creation of graph loops of size four which would degrade the performance of belief propagation (sum-product algorithm). Thus, the girth of the graph is at least six and three iterations of belief propagation are guaranteed before the assumption of independence of factor messages is violated.

Phase 2: Factor Density Estimation

Equation 1 can be refined for the case of binary data:

$${f}_{X Y} ( x , y ) = {\sum }_{{ω}_{k} , {ω}_{l} ∈ {\{ 0 , 1 \}}^{2}} {F}_{X Y} ( {ω}_{k} , {ω}_{l} ) {( - 1 )}^{( {ω}_{k} x + {ω}_{l} y )} \qquad EQUATION 5$$

where X and Y are binary random variables, and Equation 3 becomes:

F_{XY}(ωₖ,ωₗ)=¼E[(−1)^{(ω}^{ₖ}^{X+ω}^{ₗ}^{Y)}].

Three or more variables can be generalized from the form above.

In the Error Control Coding (ECC) reverse engineering example described herein, Equation 6 is estimated from the training data with Monte Carlo integration and then Equation 5 is computed to provide estimates of the component factors of system posterior density. Hence, the same training data is used to separately select dependent variable subsets and then estimate their joint density functions. In various embodiments, the disclosed technology can jointly perform dependent subset selection and density estimation.

Phase 3: Sum Product Algorithm

The PDF computed with Equation 5 can be used to implement the sum-product algorithm as follows. When computing the factor node update for variable V₁, the conditional PDF f(Vₗ|Vₘ, Vₙ) (derived from f(Vₗ, Vₘ, Vₙ)) is multiplied by the variable densities a(Vₘ) and a(Vₙ) received as messages from variable nodes Vₘ and Vₙ to obtain the joint density, which is then marginalized for the output variable Vₗ. This process is executed at each iteration of belief-propagation, for example, according to the equations defined in FIG. 4 and FIG. 5 which describe an implementation of sum-product update equations for binary data.

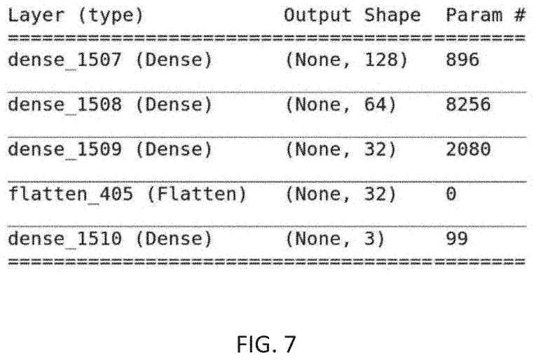

Accordingly, the phases described above in connection with FIGS. 2-5 create a factor graph with component factor densities that can operate as a decoder for a (6, 3) Hamming code. The factor graph is created without any predetermine graph structure. A comparison of factor graphs created using the present disclosure with various neural networks (FIG. 7) is described below.

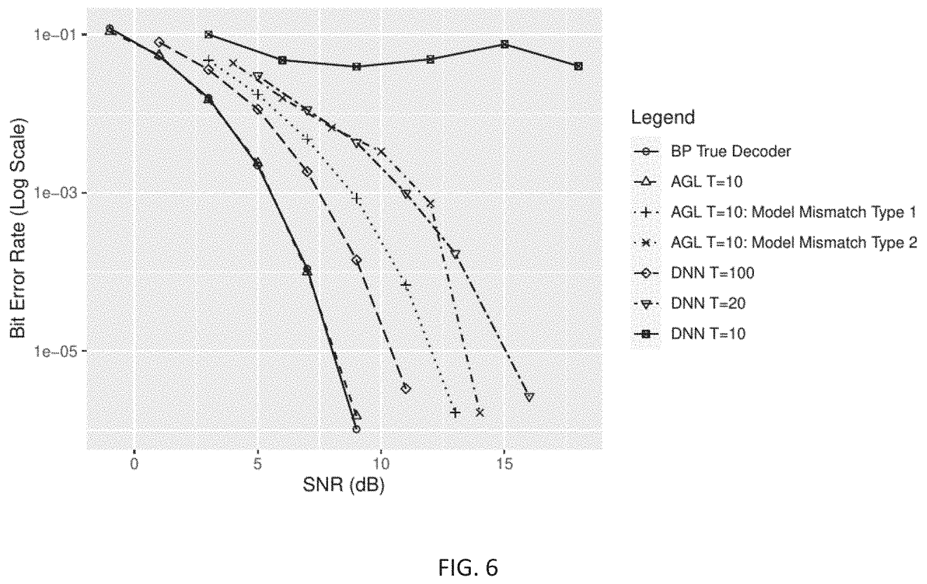

FIG. 6 illustrates results of testing the performance of Automatic Graph Learning (AGL) versus Dense Neural Network (DNN) with different number of training codeword pairs (T=10,20,100). In the test results, AGL performs as well as belief propagation with a known decoder, both with 8 iterations.

The testing implemented a belief propagation decoder using an AGL derived model as described above and compared the performance to the true decoder in FIG. 6. The result shows that, with only 10 training codeword pairs, AGL has the potential to match performance of the true decoder. When the learned factor graph corresponds to a parity check matrix whose rows span the null space of the generator matrix, there is no difference in performance between the true decoder and the AGL model.

However, depending on the realization of the 10 training data samples, the factor selection algorithm may not always select a parity matrix that is rank-six or dual to the generator. The AGL curve labeled “Model Mismatch Type 1” depicts the performance of a rank-five parity matrix (whose rows lie in the null space of the generator matrix G) after three iterations of belief propagation decoding. The result shows a 3.8 dB loss compared to ideal curve at BER=10⁻⁵. The AGL curve labeled “Model Mismatch Type 2” is rank-six but contains one factor that violates two of three orthogonality conditions (with G). Despite this impediment, the result demonstrates reasonable performance with a loss of roughly 5.5 dB compared to true decoder.

In 1000 trials of T=10 training codeword pairs, the testing found that 50.7% learned models were full-rank in the null space of G, 30.9% were rank-five in the null space of G (“Model Mismatch Type 1”), and 2.3% had one or two orthogonality constraint violations (“Model Mismatch Type 2”). The numerical results further suggest that variations on the sum-product algorithm may compensate for model mismatch. In particular, the result labeled “Model Mismatch Type 2” was developed by a sum-product decoder that used the joint factor distribution when implementing check node processing in FIG. 4, instead of the conditional form as depicted. Variations on the inference processing algorithm, including variations on the sum-product algorithm and related algorithms, are included in the scope of the present invention.

The testing designed and trained multi-layer Dense Neural Networks (DNN) with the TensorFlow/Keras toolkit and used it to decode noisy channel outputs with the same AWGN channel model used above. The parameters of the DNN are listed in FIG. 7 (Keras model summary), where the Adam optimizer was used with a mean squared error loss function. The testing found that the performance of the neural network was moderately improved by adding a small amount of AWGN to the modulated training data. The DNN is unable to match the performance of the AGL (T=10) when the parity matrix is dual to the generator, even with 100 training samples. AGL model mismatch cases yield comparable performance to DNN with T=100 and T=20 training samples. Based on the test results, AGL has the potential to outperform competitive neural networks with an order of magnitude less training data.

Accordingly, the present disclosure provides an AGL framework for applications in machine learning and artificial intelligence systems. As described herein, a suitable factor graph model can be learned by detecting dependent subsets of system variables, and component factor PDFs can be estimated using Fourier domain representations. Numerical results are provided for the ECC reverse engineering problem, which show that AGL with limited training data has the potential to provide a competitive alternative to neural networks.

In the disclosed approach, computational complexity may exist in constructing the factor graph, due to the combinatorial complexity of selecting variable subsets and of constructing an accurate model with limited training data. However, several heuristics are disclosed to reduce the candidate search space and, further, application specific prescriptions could be leveraged. For example, application specific constraints relating to statistical aspects of physical laws may be used to create the probabilistic model, which may help to reduce computational complexity. Once the graph is determined, the results show that a relatively small amount of training is usable to characterize the factor PDFs, such as only 10 training codewords to replicate the performance of the true belief propagation decoder. The results show that inference processing using belief propagation is viable even when there is a small degree of model mismatch.

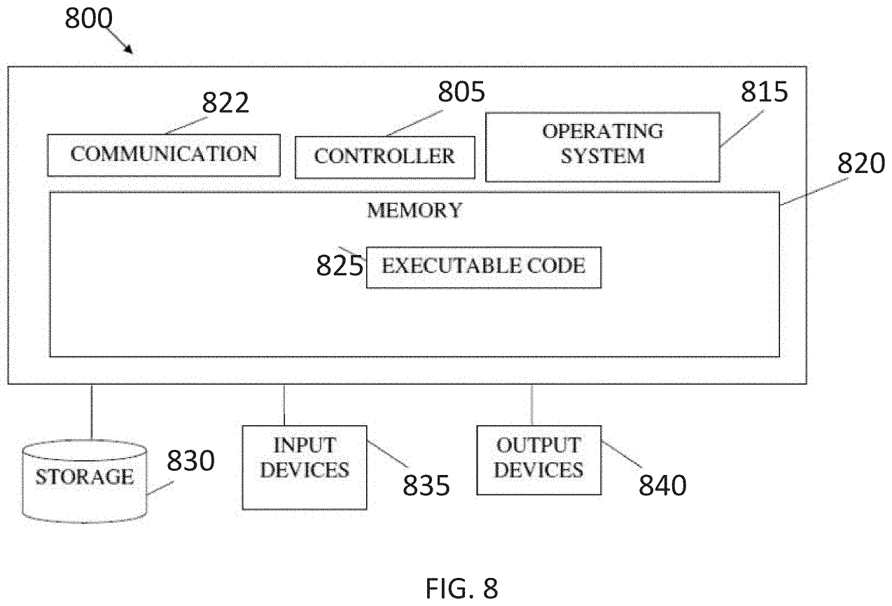

Referring now to FIG. 8, there is shown a block diagram of exemplary components of a system or device 800. The block diagram is provided to illustrate possible implementations of various parts of the disclosed systems and devices, such as the operations of FIGS. 1-5.

The computing system 800 includes a processor or controller 805 that may be or include, for example, one or more central processing unit processor(s) (CPU), one or more Graphics Processing Unit(s) (GPU or GPGPU), and/or other types of processor, such as a microprocessor, digital signal processor, microcontroller, programmable logic device (PLD), field programmable gate array (FPGA), or any suitable computing or computational device. The computing system 800 also includes an operating system 815, a memory 820, a storage 830, input devices 835, output devices 840, and a communication device 822. The communication device 822 may include one or more transceivers which allow communications with remote or external devices and may implement communications standards and protocols, such as cellular communications (e.g., 3G, 4G, 5G, CDMA, GSM), Ethernet, Wi-Fi, Bluetooth, low energy Bluetooth, Zigbee, Internet-of-Things protocols (such as mosquitto MQTT), and/or USB, among others.

The operating system 815 may be or may include any code designed and/or configured to perform tasks involving coordination, scheduling, arbitration, supervising, controlling or otherwise managing operation of computing system 800, such as scheduling execution of programs. The memory 820 may be or may include, for example, one or more Random Access Memory (RAM), read-only memory (ROM), flash memory, volatile memory, non-volatile memory, cache memory, and/or other memory devices. The memory 820 may store, for example, executable instructions that carry out an operation (e.g., executable code 825) and/or data. Executable code 825 may be any executable code, e.g., an app/application, a program, a process, task or script. Executable code 825 may be executed by controller 805.

The storage 830 may be or may include, for example, one or more of a hard disk drive, a solid state drive, an optical disc drive (such as DVD or Blu-Ray), a USB drive or other removable storage device, and/or other types of storage devices. Data such as instructions, code, procedure data, and medical images, among other things, may be stored in storage 830 and may be loaded from storage 830 into memory 820 where it may be processed by controller 805. The input devices 535 may include, for example, a mouse, a keyboard, a touch screen or pad, or another type of input device. The output devices 840 may include one or more monitors, screens, displays, speakers and/or other types of output devices.

The illustrated components of FIG. 8 are exemplary and variations are contemplated to be within the scope of the present disclosure. For example, the numbers of components may be greater or fewer than as described and the types of components may be different than as described. When the system 800 implements a machine learning system, for example, a large number of graphics processing units may be utilized. When the computing system 800 implements a data storage system, a large number of storages may be utilized. As another example, when the computing system 800 implements a server system, a large number of central processing units or cores may be utilized. Other variations and applications are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems described herein may also utilize one or more processors to receive various information and transform the received information to generate an output. The processor may include any type of computing device, computational circuit, or any type of controller or processing circuit capable of executing a series of instructions that are stored in a memory. The processor may include multiple processors and/or multicore central processing units (CPUs) and/or graphical processing units (GPUs) and may include any type of controller, such as a microprocessor, digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods or operations may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A system comprising:
one or more processors; and
at least one memory storing instructions which, when executed by the one or more processors, cause the system to:
access training data relating to a plurality of variables,
determine a factor graph model based on the training data, the factor graph model including component factors,
estimate probability density functions for the component factors based on Monte Carlo integration in frequency domain, and
apply the factor graph model with the estimated probability density functions for the component factors to new observed data to provide a prediction.

2. The system of claim 1, wherein in determining the factor graph model, the instructions, when executed by the one or more processors, cause the system to determine low-order moments based on the training data.

3. The system of claim 2, wherein in determining the factor graph model, the instructions, when executed by the one or more processors, cause the system to identify subsets of dependent variables based on the low-order moments.

4. The system of claim 3, wherein in identifying the subsets of dependent variables, the instructions, when executed by the one or more processors, cause the system to compare whether joint variable moments deviate from products of individual variable moments.

5. The system of claim 4, wherein in determining the factor graph model, the instructions, when executed by the one or more processors, cause the system to create factor nodes corresponding to the subsets of dependent variables and adding edges from the factor nodes to corresponding variable nodes.

6. The system of claim 1, wherein in estimating probability density functions for the component factors, the instructions, when executed by the one or more processors, cause the system to estimate functional forms of the probability density functions for the component factors using Fourier domain synthesis.

7. The system of claim 6, wherein in estimating probability density functions for the component factors, the instructions, when executed by the one or more processors, cause the system to estimate the probability density functions for the component factors using the functional forms, joint variable moments, and direct Monte Carlo integration in the frequency domain.

8. The system of claim 1, wherein the instructions, when executed by the one or more processors, further cause the system to apply the factor graph model with the estimated probability density functions for the component factors to observed variables to make an inference.

9. A method comprising:
accessing training data relating to a plurality of variables;
determining a factor graph model based on the training data, the factor graph model including component factors;
estimating probability density functions for the component factors based on Monte Carlo integration in frequency domain; and
applying the factor graph model with the estimated probability density functions for the component factors to new observed data to make a prediction.

10. The method of claim 9, wherein determining the factor graph model includes determining low-order moments based on the training data.

11. The method of claim 10, wherein determining the factor graph model includes identifying subsets of dependent variables based on the low-order moments.

12. The method of claim 11, wherein identifying the subsets of dependent variables includes comparing whether joint variable moments deviate from products of individual variable moments.

13. The method of claim 12, wherein determining the factor graph model includes creating factor nodes corresponding to the subsets of dependent variables and adding edges from the factor nodes to corresponding variable nodes.

14. The method of claim 9, wherein estimating the probability density functions for the component factors includes estimating functional forms of the probability density functions for the component factors using Fourier domain synthesis.

15. The method of claim 14, wherein estimating the probability density functions for the component factors includes estimating the probability density functions for the component factors using the functional forms, joint variable moments, and direct Monte Carlo integration in the frequency domain.

16. The method of claim 9, further comprising applying the factor graph model with the estimated probability density functions for the component factors to observed variables to make an inference.

17. A method comprising:
accessing training data relating to a plurality of variables;
determining a probabilistic graph model based on the training data, the probabilistic graph model including nodes and edges deduced from the training data, and the probabilistic graph model having no predetermined structure prior to the nodes and edges being deduced;
estimating probabilistic parameters of the probabilistic graph model using the training data; and
applying the probabilistic graph model with the estimated probabilistic parameters to new observed data to make a prediction.

18. The method of claim 17, wherein the probabilistic graph model is a factor graph model.
